(19) United States
(12) Patent Application Publication
(10) Pub. No.: US 2024/0211379 A1
(43) Pub. Date: Jun. 27, 2024

(54) SYSTEM VERIFICATION APPARATUS, SYSTEM VERIFICATION METHOD AND PROGRAM

(71) Applicant: Nippon Telegraph and Telephone Corporation, Tokyo (JP)

(72) Inventors: Yuichiro ISHIZUKA, Musashino-shi, Tokyo (JP); Kosuke Sakata, Musashino-shi, Tokyo (JP); Ryosuke SATO, Musashino-shi, Tokyo (JP); Yuichi SUTO, Musashino-shi, Tokyo (JP)

(21) Appl. No.: 18/288,535

(22) PCT Filed: May 10, 2021
(86) PCT No.: PCT/JP2021/017693

§ 371 Date: Oct. 26, 2023

(51) Int. Cl. G06F 11/36; G06F 11/34

(52) U.S. Cl. CPC G06F 11/3664; G06F 11/3476

(57) ABSTRACT

A system verification apparatus 1 includes a management unit 11 that manages a functional status related to an execution state of a function of a processing system using log data of the processing system constructed in a verification environment, a determination unit 12 that determines whether a value based on the functional status satisfies condition values for application to a production environment, and a renewal unit 13 that switches the function of the processing system to the production environment when the value based on the functional status satisfies the condition values for application to the production environment.

### TECHNICAL FIELD

The present invention relates to a system verification apparatus, a system verification method, and a system verification program.

### BACKGROUND ART

When a system is renewed (upgraded), the system is normally applied to a production environment after it is verified in a verification environment. Non Patent Literature 1 discloses technology for transition of a system from a test environment to a production environment.

### CITATION LIST

### Non Patent Literature

[NPL 1] “Transition from 20 test environments to production environment,” Oracle, Oracle Fusion Middleware Administering Oracle Fusion Middleware, 12c (12.2.1.1), E77326-02, [online], [Retrieved on Apr. 8, 2021], Internet <URL: https://docs.oracle.com/cd/E80149_01/lcm/ASADM/testprod.htm>

### SUMMARY OF INVENTION

### Technical Problem

However, necessary technologies and human/physical resources are different between a verification environment and a production environment, and organizations in charge of the verification environment and the production environment are often different from each other. In such a case, processes before renewal from the verification environment to the production environment require an adjustment operation with respect to delivery of a development system between different organizations, and it is expected that operations and a time period will be required for the true workload. In particular, when an agile type development system or a system close thereto is adopted, operations are cumulatively generated every time a renewal cycle is repeated. Therefore, it is necessary to provide a mechanism capable of timely renewing a production environment using a developed/modified system.

The present invention has been devised in view of the aforementioned circumstances, and an object of the present invention is to provide technology capable of easily renewing a system of a production environment.

### Solution to Problem

A system verification apparatus of one aspect of the present invention includes a management unit configured to manage a functional status related to an execution state of a function of a processing system using log data of the processing system constructed in a verification environment, a determination unit configured to determine whether a value based on the functional status satisfies condition values for application to a production environment, and a renewal unit configured to switch the function of the processing system to the production environment when the value based on the functional status satisfies the condition values for application to the production environment.

A system verification apparatus of one aspect of the present invention includes a management unit configured to manage a functional status related to an execution state of a function of a processing system using log data of the processing system constructed in a production environment, a determination unit configured to determine whether a value based on the functional status satisfies non-continuous use condition values in the production environment, and a renewal unit configured to return the function of the processing system to an old version function when the value based on the functional status satisfies the non-continuous use condition values in the production environment.

A system verification method of one aspect of the present invention, performed by a system verification apparatus, includes a step of managing a functional status related to an execution state of a function of a processing system using log data of the processing system constructed in a verification environment, a step of determining whether a value based on the functional status satisfies condition values for application to a production environment, and a step of switching the function of the processing system to the production environment when the value based on the functional status satisfies the condition values for application to the production environment.

A system verification method of one aspect of the present invention, performed by a system verification apparatus, includes a step of managing a functional status related to an execution state of a function of a processing system using log data of the processing system constructed in a production environment, a step of determining whether a value based on the functional status satisfies non-continuous use condition values in the production environment, and a step of returning the function of the processing system to an old version function when the value based on the functional status satisfies the non-continuous use condition values in the production environment.

A system verification program of one aspect of the present invention causes a computer to serve as the above-described system verification apparatus.

### Advantageous Effects of Invention

According to the present invention, it is possible to provide technology capable of easily renewing a system in a production environment.

### BRIEF DESCRIPTION OF DRAWINGS

FIG. 1 is a diagram showing an overall configuration.

FIG. 2 is a diagram showing an example of a functional block configuration of a system verification apparatus 1.

FIG. 3 is a diagram showing operation example 1 of the system verification apparatus 1.

FIG. 4 is a diagram showing a processing image of operation example 1.

FIG. 5 is diagram showing a notification example in operation example 1.

FIG. 6 is a diagram showing operation example 2 of the system verification apparatus 1.

FIG. 7 is a diagram showing a processing image of operation example 2.

FIG. 8 is diagram showing a notification example in operation example 2.

FIG. 9 is a diagram showing an example of management of a functional status.

FIG. 10 is a diagram showing an example of a hardware configuration of the system verification apparatus 1.

### DESCRIPTION OF EMBODIMENTS

Embodiments of the present invention will be described below with reference to the drawings. In the description provided with reference to the drawings, the same parts are denoted by the same reference numerals and the description thereof is omitted.

### Overview of Invention

The present invention discloses a system verification apparatus that accumulates and manages details of processing of a system and results executed in a verification environment (influence on other apparatuses, normal execution rate, and the like), and performs prescribed processing when the result values satisfy prescribed conditions (conditions for verification OK by a development organization, and the like). The system can be automatically updated when the conditions are satisfied by registering processing (U.S. Pat. No. 5,052,472 and the like) of applying the system to a production environment and updating the system as the prescribed processing, for example.

Further, the present invention discloses a system verification apparatus that accumulates and manages results (normal execution rate, processing time, and the like) obtained by executing a system in a production environment, and when the result values satisfy prescribed conditions (conditions under which a development organization prohibits continued use, and the like), performs a predetermined operation. The system can be automatically restored when the conditions are satisfied by registering system restoration processing as the predetermined operation, for example.

By using the above-described system verification apparatus, it is possible for an operator to easily check the quality of a system simply and automatically perform application to a production environment. Further, when there is an abnormality in the quality, the system can be automatically restored. It is not necessary to perform adjustment between a development organization and an operation organization every time renewal is performed, and thus reduction of workload for verification and operation can be expected.

### Overall Configuration

A system verification apparatus according to the present embodiment has a function of managing the status of a functional unit in a verification environment of a processing system having one or more functions developed and modified by a developer, and a function of managing the status of a functional unit in a production environment of the system. The status of the function unit is a normal execution rate of each function, or the like.

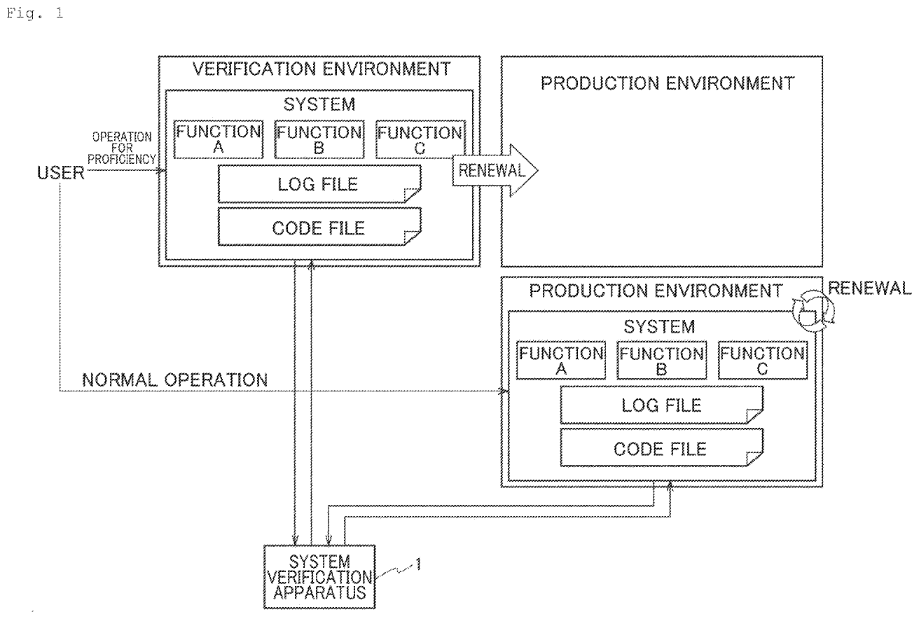

As shown in FIG. 1, a user (a developer of a development organization, a verifier of a verification organization, an operator of an operation organization, or the like) of the system verification apparatus 1 appropriately executes the system in a verification environment. For example, an operation for learning the system is assumed. At this time, a log file is generated in the system of the verification environment as a history of function execution of the system. The system verification apparatus 1 calculates and manages a normal execution rate or the like of a function unit of the system on the basis of the log file and a code file of the system. When the normal execution rate or the like of each function satisfies a predetermined conditional expression (when sufficient quality is secured), the system verification apparatus 1 applies a function satisfying the conditional expression to a production environment and updates the function by executing predetermined processing.

As shown in FIG. 1, the user of the system verification apparatus 1 appropriately executes the system in the production environment. For example, normal operation of the system is assumed. At this time, a log file is generated in the system of the production environment as a history of function execution of the system. The system verification apparatus 1 calculates and manages a normal execution rate, a processing time, and the like of a function unit in the production environment on the basis of the log file and a code file of the system. When the normal execution rate, processing time, and the like of each function satisfy a predetermined conditional expression (when it is observed that the quality is abnormally deteriorated), the system verification apparatus 1 executes prescribed processing to restore a function satisfying the conditional expression.

### [Example of Configuration of System Verification Apparatus]

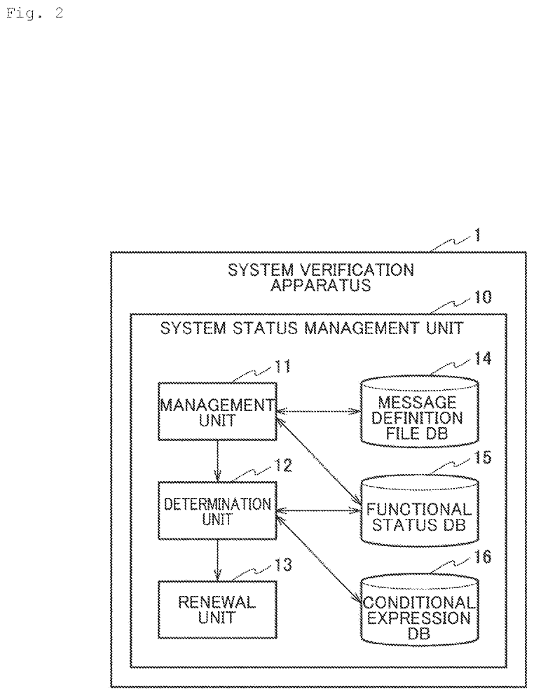

FIG. 2 is a diagram showing an example of a functional block configuration of the system verification apparatus 1 according to the present embodiment. The system verification apparatus 1 includes a system status management unit 10. The system status management unit 10 has a function of managing the status of each function of a processing system in a verification environment developed and modified by a developer. The system status management unit 10 has a function of managing the status of each function of a processing system in a production environment in which a service is actually operated.

In order to manage the status of each function of the system, the system status management unit 10 includes, for example, a management unit 11, a determination unit 12, a renewal unit 13, a message definition file DB 14, a functional status DB 15, and a conditional expression DB 16. The names of these functional units may be represented as a processing unit, an execution unit, a control unit, a processing execution unit, a storage unit, and the like. A plurality of functional units may be integrated into one functional unit, or one functional unit may be divided into a plurality of functional units.

The management unit 11 has a function of managing a functional status related to an execution state of a function of a system constructed in a verification environment using a log file or a code file of the system. Further, the management unit 11 has a function of managing a functional status related to an execution state of a function of a system constructed in a production environment using a log file or a code file of the system.

The determination unit 12 has a function of determining whether or not a value based on a functional status satisfies condition values for application to the production environment. The determination unit 12 has a function of determining whether or not the value based on the functional status satisfies non-continuous use condition values in the production environment.

The renewal unit 13 has a function including a function of switching the function of the system to the production environment by executing prescribed processing when the value based on the functional status satisfies the condition values for application to the production environment. Further, the renewal unit 13 has a function of returning (restoring) the function of the system to the function of the old version by executing prescribed processing when the value based on the functional status satisfies the non-continuous use condition values in the production environment.

The message definition file DB 14 has a function of storing a message definition file in which key information for acquiring a predetermined message or the like from a log file or a code file is defined.

The functional status DB 15 has a function of storing a functional status related to an execution state of a function of the system.

The conditional expression DB 16 has a function of storing the condition values for application to the production environment and the non-continuous use condition values in the production environment.

### [Operation Example of System Verification Apparatus]

### Operation Example 1

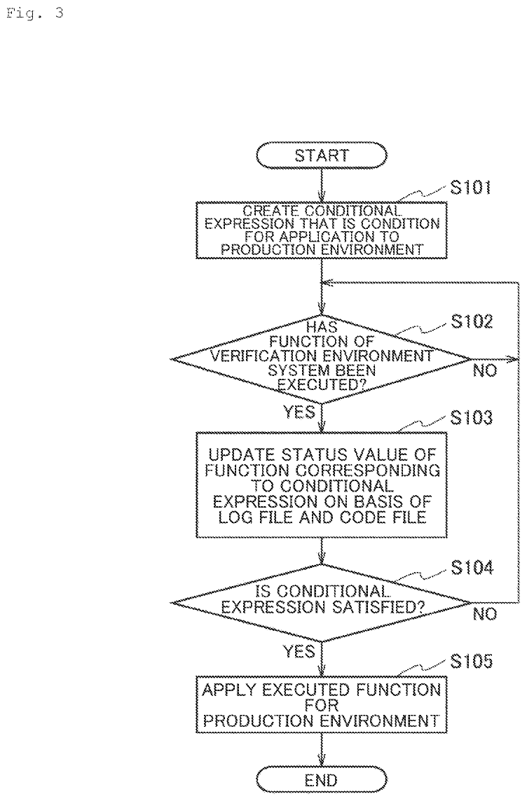

FIG. 3 is a diagram showing operation example 1 of the system verification apparatus 1. It is assumed that a user of the system verification apparatus 1 appropriately executes a system in a verification environment. For example, an operation for proficiency of the system is assumed.

### Step S101;

First, the operator of the system verification apparatus 1 creates and determines application conditions (condition values for application to a production environment) as criteria for application to the production environment in advance. Then, the system verification apparatus 1 registers the determined application conditions in the conditional expression DB 16 as a conditional expression list.

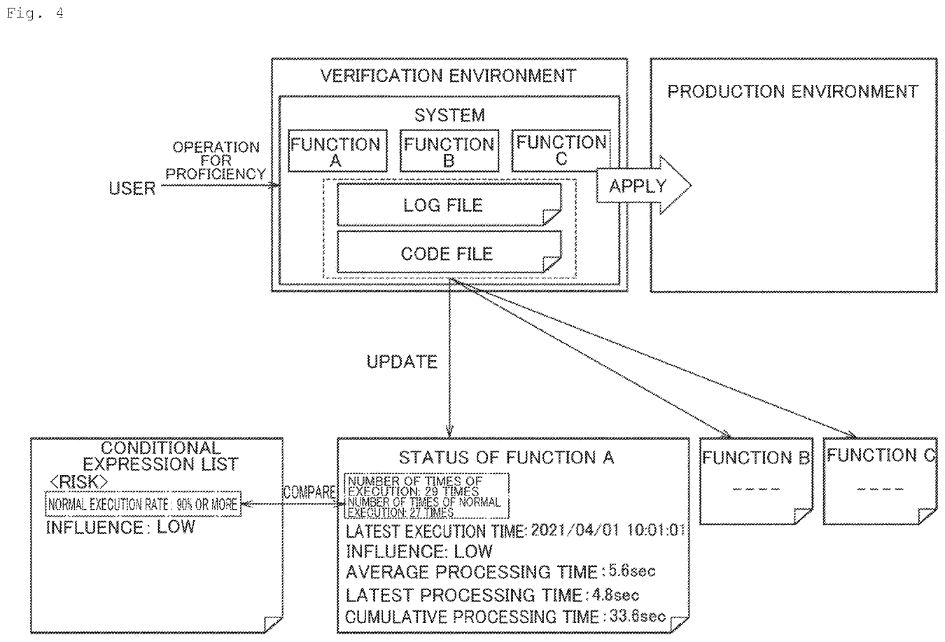

For example, the operator of the system verification apparatus 1 registers an influence on the production environment automatically calculated by scanning the code of a function, and a normal execution rate of the function calculated from a function execution result as a conditional expression list, as shown in FIG. 4.

The influence is set to “low” when the code of the function is read-only such as only HTTP GET. On the other hand, when the code of the function includes writing processing such as “register,” “delete,” or “update,” such as HTTP POST, the influence is set to “high.” A value corresponding to the influence is set to the normal execution rate. For example, when the influence is “low,” “90% or more” is set. When the influence is “high,” “95% or more” is set.

### Step S102;

Next, the system verification apparatus 1 determines whether or not a function of the system in the verification environment has been executed. For example, the system verification apparatus 1 refers to a log file generated by the system, and determines that the function has been executed when a log indicating execution of the function is newly added to the log file. The system verification apparatus 1 proceeds to step S103 when the function has been executed and repeats step S102 until the function is executed when the function has not been executed.

### Step S103;

Each time the function of the system is executed in the verification environment, the system verification apparatus 1 acquires, calculates, and updates values corresponding to the application conditions of the conditional expression list.

For example, the management unit 11 of the system verification apparatus 1 acquires the log file of the system and a code file of the executed function from the system in the verification environment. Then, the management unit 11 acquires an acquisition target message defined in a message definition file from the log file and the code file. Thereafter, the management unit 11 updates the values corresponding to the application conditions of the conditional expression list on the basis of the acquisition target message. For example, when a function A has been executed, the number of times of execution and the number of times of normal execution included in the functional status of the function A are updated, as shown in FIG. 4.

In this manner, the management unit 11 updates the functional status of each executed function each time each function of the system is executed in the verification environment, and accumulates each updated functional status in the functional status DB 15 to manage it.

### Step S104;

Each time the functional status is updated, the system verification apparatus 1 checks whether the updated functional status satisfies the application conditions of the conditional expression list.

For example, the determination unit 12 of the system verification apparatus 1 calculates a normal execution rate [%] of the function A at the present time by dividing the number of times of normal execution included in the updated functional status of the function A by the number of times of execution. Thereafter, as shown in FIG. 4, the determination unit 12 compares the normal execution rate EX1 of the function A at the present time with a normal execution rate EX2 of the function A registered in the conditional expression list.

When the normal execution rate EX1 is equal to or higher than the normal execution rate EX2, the determination unit 12 determines that the function A satisfies the application conditions that are criteria for application to the production environment and proceeds to step S104. On the other hand, when the normal execution rate EX1 is less than the normal execution rate EX2, the determination unit 12 determines that the function A does not satisfy the application conditions that are criteria for application to the production environment and returns to step S102.

### Step S105;

When the application conditions are satisfied, the system verification apparatus 1 introduces the system into an operation environment.

For example, when the normal execution rate EX1 of the function A at the present time is equal to or higher than the normal execution rate EX2 of the function A registered in the conditional expression list, the renewal unit 13 of the system verification apparatus 1 applies a function that satisfies the application conditions to the production environment to update it by executing prescribed processing such as processing of switching program setting information disclosed in U.S. Pat. No. 5,052,472.

For example, the verification environment is constructed in a LAN environment shared by the production environment, and the renewal unit 13 applies the function that satisfies the application conditions to the production environment to update it by rewriting address settings of the system to address setting of the production environment.

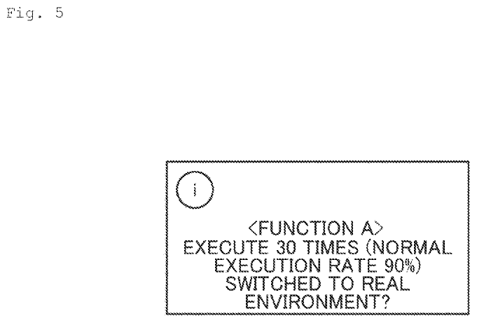

In addition, the renewal unit 13 may display a switching confirmation message as shown in FIG. 5 on the display of the system verification apparatus 1 to notify the user of switching to the production environment, and execute application to the production environment only when the user selects OK.

### Operation Example 2

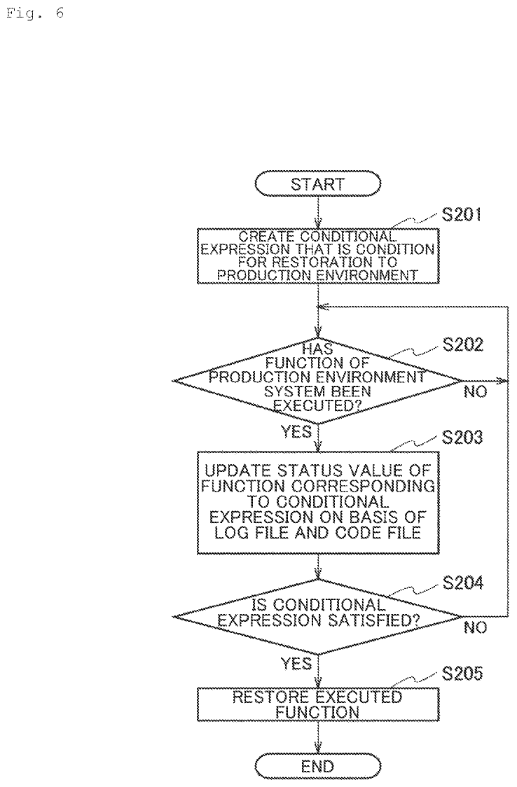

FIG. 6 is a diagram showing operation example 2 of the system verification apparatus 1. It is assumed that the user of the system verification apparatus 1 appropriately executes a system in a production environment. For example, a normal operation of the system is assumed.

### Step S201;

First, the operator of the system verification apparatus 1 creates and determines application conditions (non-continuous use condition values in the production environment) which are application criteria for function restoration of the production environment in advance. Then, the system verification apparatus 1 registers the determined application conditions in the conditional expression DB 16 as a conditional expression list.

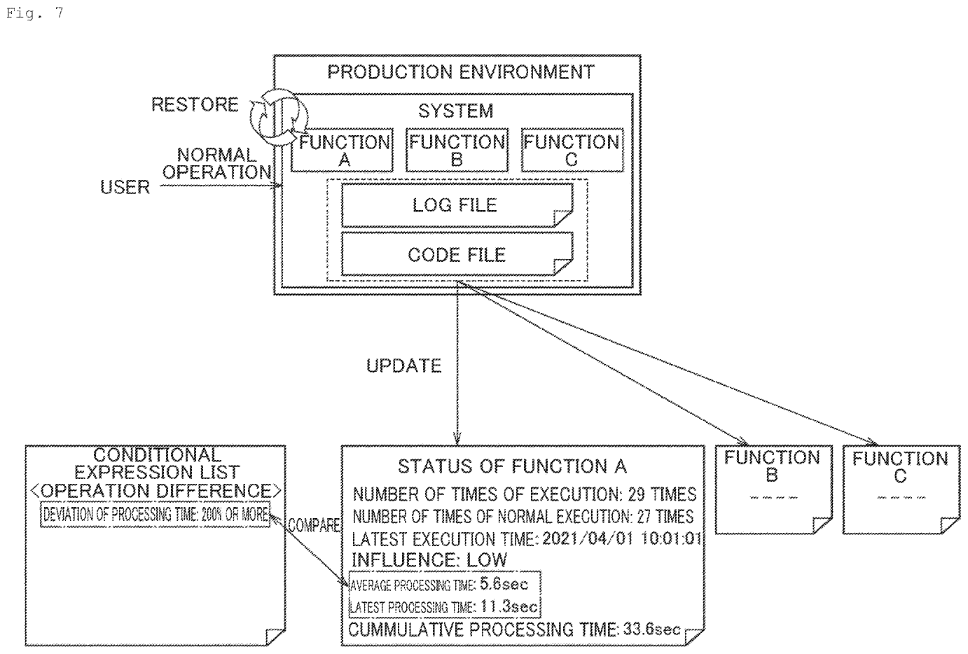

For example, the operator of the system verification apparatus 1 registers, as a conditional expression list, a deviation value of a processing time indicating how much the latest processing time of a function exceeds an average processing time, or the like, as shown in FIG. 7.

### Step S202;

Next, the system verification apparatus 1 determines whether or not a function of the system in the production environment has been executed. For example, the system verification apparatus 1 refers to a log file generated by the system, and determines that the function has been executed when a log indicating execution of the function is newly added to the log file. The system verification apparatus 1 proceeds to step S203 when the function has been executed and repeats step S202 until the function is executed when the function has not been executed.

### Step S203;

Each time the function of the system is executed in the production environment, the system verification apparatus 1 acquires, calculates, and updates values corresponding to the application conditions of the conditional expression list.

For example, the management unit 11 of the system verification apparatus 1 acquires the log file of the system and a code file of the executed function from the system in the production environment. Then, the management unit 11 acquires an acquisition target message defined in a message definition file from the log file and the code file. Thereafter, the management unit 11 updates the values corresponding to the application conditions of the conditional expression list on the basis of the acquisition target message. For example, when the function A has been executed, the average processing time and the latest processing time included in the functional status of the function A are updated, as shown in FIG. 7.

In this manner, the management unit 11 updates the functional status of each executed function each time each function of the system is executed in the production environment, and accumulates each updated functional status in the functional status DB 15 to manage it.

### Step S204;

Each time the functional status is updated, the system verification apparatus 1 checks whether the updated functional status satisfies the application conditions of the conditional expression list.

For example, the determination unit 12 of the system verification apparatus 1 calculates a deviation value [%] of the processing time of the function A at the present time by dividing the latest processing time included in the updated functional status of the function A by the average processing time. Thereafter, the determination unit 12 compares a deviation value DI1 of the processing time of the function A at the present time with a deviation value DI2 of the processing time of the function A registered in the conditional expression list, as shown in FIG. 7,

When the deviation value DI1 of the processing time is equal to or greater than the deviation value DI2 of the processing time, the determination unit 12 determines that the function A satisfies the application conditions that are application criteria for function restoration of the production environment, and proceeds to step S204. On the other hand, when the deviation value DI1 of the processing time is less than the deviation value DI2 of the processing time, the determination unit 12 determines that the function A does not satisfy the application conditions that are application criteria for function restoration of the production environment, and returns to step S202.

### Step S205;

When the application conditions are satisfied, the system verification apparatus 1 introduces the system into an operation environment.

For example, when the deviation value DI1 of the processing time of the function A at the present time is equal to or greater than the deviation value DI2 of the processing time of the function A registered in the conditional expression list, the renewal unit 13 of the system verification apparatus 1 restores the function satisfying the application conditions by executing prescribed processing.

For example, functions of the old version are held, and the renewal unit 13 restores the function satisfying the application conditions by inputting a command for switching a connection destination of the function to a function of the old version.

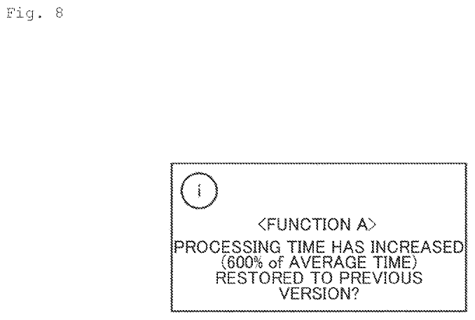

In addition, the renewal unit 13 may display a switching confirmation message as shown in FIG. 8 on the display of the system verification apparatus 1 to notify the user of switching of the production environment, and execute function restoration only when the user selects OK.

### [Method of Managing Functional Status]

### [Method for Acquiring Acquisition Target Message]

A method of acquiring an acquisition target message from a log file or a code file, which is performed in step S103 and step S203, will be explained.

The operator of the system verification apparatus 1 specifies in advance character strings included in an execution message, an end message, and the like in a log file or a code file in order to determine that execution of a function, end of execution, or the like is included in the log file or the code file. The system verification apparatus 1 records the specified character strings in a message definition file and registers the message definition file in the message definition file DB 14.

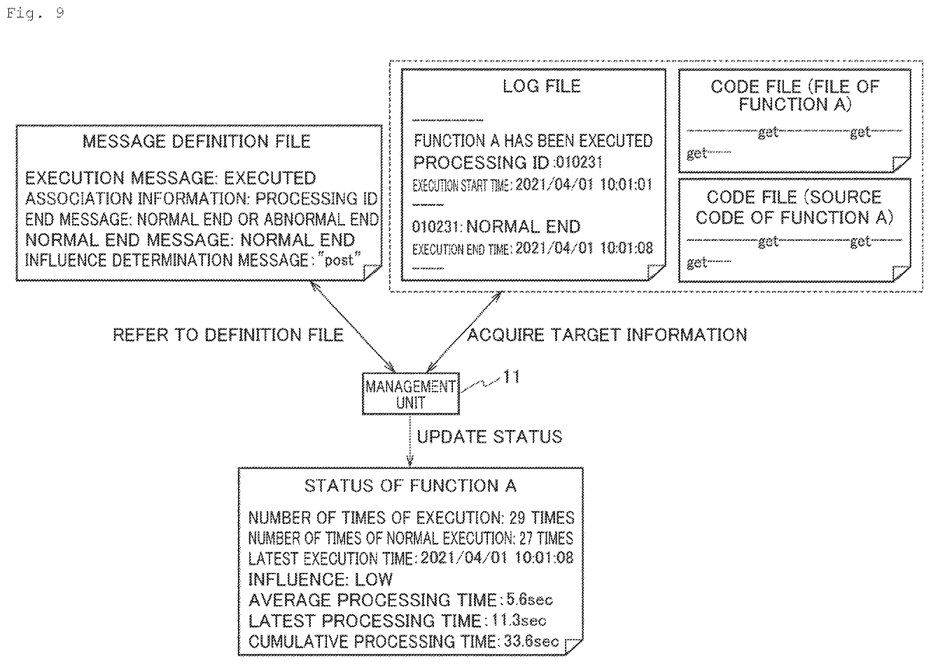

For example, the operator of the system verification apparatus 1 records character strings such as “executed” as an execution message, a processing ID as association information, “normal end” or “abnormal end” as an end message, “normal end” as a normal end message, and “post” as an influence determination message in the message definition file, as shown in FIG. 9.

The management unit 11 of the system verification apparatus 1 performs replacement on the basis of the character strings recorded in the message definition file at the time of scanning log data of the log file and code data of the code file in the system, and detects information necessary to manage the functional status, such as “executed,” “ended,” and “normally ended,” in the log file and the code file depending on whether or not the character strings are included.

For example, when the same character string as a character string recorded in the message definition file is included in the log file, the management unit 11 acquires an acquisition target message such as the ID of an executed function, an execution result (normal end or abnormal end), an execution start time, and an execution end time from log information in the log file associated with parts before and after the character string or processing IDs included before and after the character string.

### [Method of Updating Functional Status]

A method of updating a functional status which is performed in step S103 and step S203 will be described.

As shown in FIG. 9, a functional status includes, for example, the number of times of execution of a function, the number of times of normal execution, the latest execution time, an influence, an average processing time, the latest processing time, a cumulative processing time, and the like.

The number of times of execution and the number of times of normal execution are calculated for each execution unit of the function, each renewal unit of the function, or each renewal unit of the system. Specifically, when the execution end time of a function included in a log file acquired by periodic execution is newer than the latest time accumulated in the functional status of the function, 1 is added to the number of times of execution of the functional status. When the execution of the function is normally ended, 1 is added to the number of times of normal execution.

For example, a message “Function A has been executed” in the log file is retrieved, and when the execution time of the function A has not been already checked, the number of times of execution is increased. Further, when result code corresponding to the message normally ends, the number of times of normal execution is increased.

The latest execution time is defined as an execution end time of a function included in the log file.

The influence is also calculated for each execution unit of a function, each renewal unit of the function, or each renewal unit of the system. Specifically, a code file of an executed function is retrieved, and “high” is set when the code file has a function of registration, update, and deletion and “low” is set when the code file has no function of registration, update, and deletion. For example, in the case of the REST format, “high” is set if “POST” is included in the code file and “low” is set if “POST” is not included therein. The influence of each function is updated when the execution time of the executed function is updated. A code file is, for example, source code of a function before compilation and source code included in a file of the function if the function can be executed without the need of compilation.

The average processing time, the latest processing time, and the cumulative processing time are also calculated for each execution unit of a function, each renewal unit of the function, or each renewal unit of the system. Specifically, when the execution end time of a function included in a log file acquired by periodic execution is newer than the latest time accumulated in the functional status of the function, the execution end time and the execution start time associated with the execution end time are acquired, and a value obtained by subtracting the execution start time from the execution end time is set as the latest processing time. The cumulative processing time is updated by adding the latest processing time to the cumulative processing time of the functional status. A value obtained by dividing the cumulative processing time by the number of times of execution is defined as the average processing time.

### Modified Example: Another Example of Method for Calculating Normal Execution Rate

In step S104, the normal execution rate is calculated by dividing the number of times of normal execution by the number of times of execution. However, when the normal execution rate is obtained by the calculation method, the normal execution rate becomes 100 when execution is performed once and success is achieved once, and thus a conditional expression is easily satisfied when results are insufficient. Therefore, the normal execution rate may be calculated using the number of times of normal execution assuming that execution has failed for the next execution time. That is, a value obtained by dividing a value, obtained by subtracting a predetermined number from the number of times of normal execution, by the number of times of execution is defined as the normal execution rate. For example, the normal execution rate is set to 90% (=9÷10) on the assumption that the tenth execution fails even if the tenth execution is successful after execution nine times and success nine times. Accordingly, it is easy to exclude cases where results are insufficient.

### Effects

According to the present embodiment, the system verification apparatus 1 includes the management unit 11 that manages a functional status related to an execution state of a function of a processing system using log data of the processing system constructed in a verification environment, the determination unit 12 that determines whether a value based on the functional status satisfies condition values for application to a production environment, and the renewal unit 13 that switches the function of the processing system to the production environment when the value based on the functional status satisfies the condition values for application to the production environment.

According to the present embodiment, the system verification apparatus 1 includes the management unit 11 that manages a functional status related to an execution state of a function of a processing system using log data of the processing system constructed in a production environment, the determination unit 12 that determines whether a value based on the functional status satisfies non-continuous use condition values in the production environment, and the renewal unit 13 that returns the function of the processing system to an old version function when the value based on the functional status satisfies the non-continuous use condition values in the production environment.

By using the aforementioned system verification apparatus, it is possible for an operator to easily check the quality of the system simply and automatically perform application to the production environment. That is, the system verification apparatus automatically applies a system to the production environment if the user (operator) thereof performs only the operation for proficiency.

Further, by using the system verification apparatus, a system in the production environment can be automatically restored when there is an abnormality in the quality.

Further, by using the system verification apparatus, adjustment between a development organization and an operation organization need not be performed for each renewal, and thus reduction of workload in verification and operation can be expected. In particular, in agile type development, cooperation between a development organization and an operation organization can be simplified. Since a developer may simply release function files of a developed and modified system and then accumulate knowledge in the form of a conditional expression, an adjustment operation at the time of updating is not required.

### Others

The present invention is not limited to the above embodiment. The present invention can be modified in a number of ways within the scope of the gist of the present invention.

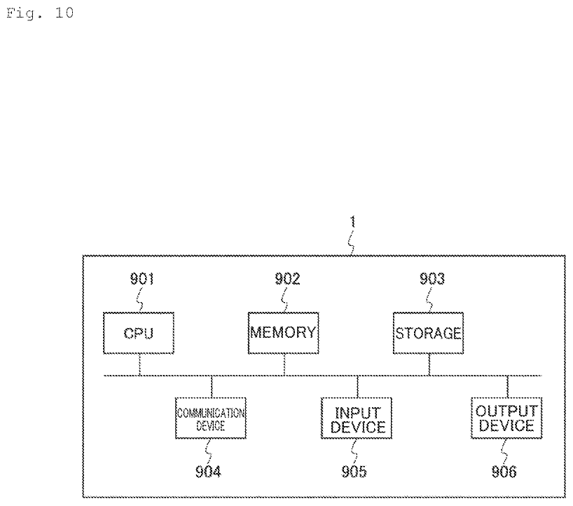

The system verification apparatus 1 of the present embodiment described above can be realized using, for example, a general-purpose computer system including a CPU 901, a memory 902, a storage 903, a communication device 904, an input device 905, and an output device 906, as shown in FIG. 10. The memory 902 and the storage 903 are storage devices. In the computer system, each function of the system verification apparatus 1 is realized by the CPU 901 executing a predetermined program loaded on the memory 902.

The system verification apparatus 1 may be implemented using one computer. The system verification apparatus 1 may be implemented using a plurality of computers. The system verification apparatus 1 may be a virtual machine mounted on a computer. A program for the system verification apparatus 1 can be stored in a computer-readable recording medium such as an HDD, an SSD, a USB memory, a CD, or a DVD. The program for the system verification apparatus 1 can also be distributed via a communication network.

### REFERENCE SIGNS LIST

1: System verification apparatus
10: System status management unit
11: Management unit
12: Determination unit
13: Renewal unit
14: Message definition file DB
15: Functional status DB
16: Conditional expression DB
901: CPU
902: Memory
903: Storage
904: Communication device
905: Input device
906: Output device

1. A system verification apparatus comprising:
a management unit, including one or more processors, configured to manage a functional status related to an execution state of a function of a processing system using log data of the processing system constructed in a verification environment;
a determination unit including one or more processors, configured to determine whether a value based on the functional status satisfies condition values for application to a production environment; and
a renewal unit including one or more processors, configured to switch the function of the processing system to the production environment when the value based on the functional status satisfies the condition values for application to the production environment.

2. A system verification apparatus comprising:
a management unit, including one or more processors, configured to manage a functional status related to an execution state of a function of a processing system using log data of the processing system constructed in a production environment;
a determination unit including one or more processors, configured to determine whether a value based on the functional status satisfies non-continuous use condition values in the production environment; and
a renewal unit, including one or more processors, configured to return the function of the processing system to an old version function when the value based on the functional status satisfies the non-continuous use condition values in the production environment.

3. The system verification apparatus according to claim 1, wherein
the renewal unit is configured to switch the function of the processing system to the production environment when a normal execution rate of the function based on the functional status satisfies the condition values for application to the production environment.

4. The system verification apparatus according to claim 2, wherein
the renewal unit is configured to return the function of the processing system to the old version function when a deviation value between a latest processing time and an average processing time of the function based on the functional status satisfies the non-continuous use condition values in the production environment.

5. The system verification apparatus according to claim 3, wherein
the normal execution rate of the function is a value obtained by dividing a value, obtained by subtracting a predetermined number from a number of times of normal execution, by a number of times of execution.

6. A system verification method, performed by a system verification apparatus, comprising:
a step of managing a functional status related to an execution state of a function of a processing system using log data of the processing system constructed in a verification environment;
a step of determining whether a value based on the functional status satisfies condition values for application to a production environment; and
a step of (i) switching the function of the processing system to the production environment when the value based on the functional status satisfies the condition values for application to the production environment, or (ii) returning the function of the processing system to an old version function when the value based on the functional status satisfies the non-continuous use condition values in the production environment.

7. (canceled)

8. A non-transitory computer-readable storage medium storing a system verification program for causing a computer to serve as the system verification apparatus according claim 1.
